(19) United States
(12) Patent Application Publication
(10) Pub. No.: US 2018/0340705 A1
(43) Pub. Date: Nov. 29, 2018

(54) Actuating Drive

(71) Applicant: Siemens Schweiz AG, Zuerich (CH)

(72) Inventors: Florian Böttger, Baar (CH); Marcel Epp, Hünenberg (CH); Andreas Pally, Allenwinden (CH)

(73) Assignee: Siemens Schweiz AG, Zuerich (CH)

(21) Appl. No.: 15/580,842

(22) PCT Filed: Jun. 3, 2016
(86) PCT No.: PCT/EP2016/062585

§ 371 Date: Dec. 8, 2017

(30) Foreign Application Priority Data
Jun. 10, 2015 (DE) 10 2015 210 648.9

(51) Int. Cl. F24F 13/14; H02K 7/116

(52) U.S. Cl. CPC F24F 13/1426; H02K 7/116; F24F 2013/146; F24F 2013/1446; F24F 2013/1433

(57) ABSTRACT

The present disclosure relates to design and implementation of an actuating drive, typically including at least a motor, a gear mechanism, and an actuator connection, wherein the motor drives the actuator connection by means of the gear mechanism. For example, an actuating drive may include: a motor; a gear mechanism; an actuator connection, wherein the motor drives the actuator connection through the gear mechanism; and a spring suitable to act on the actuator connection independently of the gear mechanism.

### CROSS-REFERENCE TO RELATED APPLICATIONS

This application is a U.S. National Stage Application of International Application No. PCT/EP2016/062585 filed Jun. 3, 2016, which designates the United States of America, and claims priority to DE Application No. 10 2015 210 648.9 filed Jun. 10, 2015, the contents of which are hereby incorporated by reference in their entirety.

### TECHNICAL FIELD

The present disclosure relates to design and implementation of an actuating drive, typically including at least a motor, a gear mechanism, and an actuator connection, wherein the motor drives the actuator connection by means of the gear mechanism.

### BACKGROUND

Typically, atuating drives are at least equipped with a motor, with a more or less complex gear mechanism, and with an actuator connection. The motor is suitable for driving the actuator connection by means of the gear mechanism. The motor may be an electric motor. The gear mechanism is connected downstream from the motor and is typically a reduction gear. The actuator connection forms the gear mechanism-side drive take-off. The actuator connection is arranged to rotate around its axis for actuating operation within a predetermined range of angles of rotation. The two ends of the range of angles of rotation correspond to a first and second end position. The first end position can also be referred to as idle position or start position and the second end position as required position or actuation position.

The motor might include a synchronous electric motor or a compressed air cylinder. Depending on the type of application, these actuating drives contain a return spring to drive the actuator connection in the opposite direction. Because the return spring is not intended to exert the full return force over the short path at the actuator connection, it typically acts to transmit the force somewhere in the gear mechanism.

The return spring, in the event of the actuating drive being deflected from an idle position, serves to apply a return force to it. For a (desired) switching-off of the actuating drive or also for an (undesired) outage of the power supply of the actuating drive, said drive then moves automatically back into the idle position. A flap connected to the actuator connection or a valve connected thereto will be closed automatically. In some cases, the motor can provide drive in two directions. Brushless direct current electric motors have the advantage of making battery operation easier.

Such actuating drives are used in systems for heating, ventilation, and/or cooling in a building, in particular to drive air flaps. For these and similar purposes the actuating drives are typically required to be reliable, durable, low-cost, compact and able to be manufactured in large volumes. Likewise, it is important for the actuating drives to generate little noise, because they will often be installed in the vicinity of living spaces or working spaces. This applies all the more to actuating drives for air flaps, which are namely arranged in or on air ducts that are typically made of sheet metal. The noise level rises in particular for a short time as a result of the actuator connection reaching a stop in its end position, which is why known measures reduce its speed as it approaches said position. However, noises also occur under some circumstances and erratically during its movement. This is above all a problem with actuating drives with a powerful motor.

### SUMMARY

The insight underlying the present disclosure is that the noises during operation of such actuating drives can be significantly reduced with simple mechanical means, without reducing their power, efficiency, or service life by doing so.

For example, some embodiments may include an actuating drive, at least with a motor (3), with a gear mechanism (4) and with an actuator connection (5), wherein the motor (3) is suitable for driving the actuator connection (5) by means of the gear mechanism (4), characterized in that the actuating drive comprises a spring (6), which is suitable to act on the actuator connection (5) independently of the gear mechanism (4).

In some embodiments, the actuating drive has a housing (2), wherein the spring (6) has a first and a second end, wherein the first end of the spring (6) is connected to the housing (2) and wherein the second end of the spring (6) is fastened to the actuator connection (5) to act directly with a torque (M_{F}) on the actuator connection (5)

In some embodiments, the actuating drive has a housing (2), wherein the spring (6) has a first and a second end, wherein the first end of the spring (6) is connected to the housing (2) and wherein the second end of the spring (6) is fastened to a body that is suitable for applying a torque (M_{F}) directly to the actuator connection (5).

In some embodiments, the body is a gear wheel, a toothed segment, an arm or a connecting rod.

In some embodiments, the spring (6) is pre-tensioned, in order to act on the actuator connection (5) with a torque (M_{F}) in each rotational position of the actuator connection (5).

In some embodiments, the spring (6) is suitable, in each rotational position of the actuator connection (5), for acting on the actuator connection (5) in a first direction or in a second direction opposite to said direction.

In some embodiments, the spring (6) is suitable, in each rotational position of the actuator connection (5), for acting on the actuator connection (5) with a torque (M_{F}) that is greater than 20% of the maximum torque (M_{F}), with which the spring (6) acts on it in the optimum rotational position of the actuator connection (5).

In some embodiments, without actuation of the motor (3), the spring (6) is not suitable in any rotational position of the actuator connection (5) for driving the non-connected actuator connection (5)

In some embodiments, the spring (6) is a bending spring, a torsion spring, a tension spring or a compression spring.

In some embodiments, the spring (6) is arranged coaxially to the axis of rotation (A) of the actuator connection (5).

In some embodiments, a torque (M_{F}) applied by the spring (6) to the actuator connection (5), in no rotational position of the actuator connection (5), is greater than 30%, in particular greater than 15%, of the nominal torque at the actuator connection (5) applied by the motor (3) by means of the gear mechanism (4).

In some embodiments, the motor (3) is suitable, by means of the gear mechanism (4) for driving the actuator connection (5) in a first direction and in a second, opposite direction thereto.

In some embodiments, the gear mechanism (4) has a motor-side gear wheel (41), a take-off-side gear wheel (46) as part of the actuator connection (5) as well as at least one gear wheel (42-45) connected between the two, wherein one gear wheel (42, 43; 44, 45) of the at least one gear wheel (42-45) connected between the two is connected to a return spring (7), which is intended to apply a reversing torque (M_{R}) to the actuating drive for a reverse operation, in the event of the drive being deflected from an idle position, and wherein the spring (6) is pre-tensioned, in order, in each rotational position of the actuator connection (5), to act with a torque (M_{F}) on the actuator connection (5) against the drive direction of the actuator connection (5) from the idle position into an actuation direction.

In some embodiments, the motor (3) is a brushless direct current electric motor.

In some embodiments, the actuating drive is configured and intended for use in a system for heating, ventilation or cooling in a building.

### BRIEF DESCRIPTION OF THE DRAWINGS

An exemplary embodiment will be explained below with reference to the figures.

FIG. 1 shows an example actuating drive for an air flap in a system for heating, ventilation, or cooling in a building in accordance with teachings of the present disclosure.

FIG. 2 shows the same actuating drive as is shown in FIG. 1, without the upper part of its housing, without its circuit board, without its electrochemical capacitors and without its connecting cable for the purposes of external power supply and control in accordance with teachings of the present disclosure.

FIG. 3 shows the same actuating drive as is shown in FIG. 2 without the toothed segment of its actuator connection in accordance with teachings of the present disclosure.

FIG. 4 shows the same actuating drive as is shown in FIG. 3 without its motor, without its metal plate for fastening the motor and without its actuator connection in accordance with teachings of the present disclosure.

FIG. 5 shows a schematic diagram of a gear mechanism of the inventive actuating drive in its idle position with a return spring for reverse operation and with a spring acting directly on the actuator connection in accordance with teachings of the present disclosure.

### DETAILED DESCRIPTION

Under some circumstances noises suddenly occur while the actuator connection is being driven. The motor itself barely contributes to this and in any event motor noise tends to be more even. Changes in load at the actuator connection, then, play a disproportionate role in the total noise generated. A varying or even sometimes negative external load might have an effect on the gear mechanism, by means of which the movement generated by the motor will be translated into a movement of the actuator connection. With changing external forces on the actuator connection friction or impacts increasingly arise between the moving parts of the transmission during this translation. This so-called backlash, with the noises and impacts associated therewith, comes into effect in particular during a change of load and during a change in the direction of rotation of the actuating drive or of the motor.

In some embodiments, an actuating drive comprises a spring, which is suitable to act on the actuator connection independently of the gear mechanism. This spring can also be referred to as the actuator connection spring. With a bidirectional motor in particular this action of the spring has the effect on average of causing a different effort in the opposing directions of travel, which might have a negative effect on the minimum power, the efficiency and the service life. In any event the risk of an overcurrent increases in an electric motor because of a large negative load when a powerful spring is acting additionally on the actuator connection in the drive direction. This could lead to the obvious disadvantage that a larger electric motor will be needed.

In some embodiments, even a comparatively small spring force or a small torque is sufficiently large to suppress the noises during the drive to a large extent. In some embodiments, without actuation of the motor, the spring is not suitable in any state of the actuator connection, in any rotational setting of the actuator connection, to drive the non-connected actuator connection without a connected load such as flap or valve. Electric motors in particular, in the absence of any power applied to them by the magnetism, may be blocked up to a threshold value.

In some embodiments, the spring is pre-tensioned or has a pre-tensioning, in order to act with a torque on the actuator connection in any rotational position of the actuator connection. The spring thus already has a pre-tensioning for application of a torque to the actuator connection in the idle position of the actuating drive. In some embodiments, then, in each rotational position of the actuator connection, the tooth flanks of the gear wheels of the gear mechanism lie against one another without any play.

In some embodiments, in each rotational position of the actuator connection, the spring is suitable to act or is designed to act on the actuator connection in a first direction or in a second direction opposite thereto and to apply a torque. In both cases the gear wheels of the transmission of the actuating drive lie against one another without any play. The motor here may comprise an electric motor operating bidirectionally, wherein the actuating drive then has no return spring for a reverse operation.

The first direction can be referred to as the drive direction, to move the actuator connection from the idle position into the actuation position. The second direction can also be referred to as the reversing direction. If driving the actuator connection causes it to rotate, then the torque at the actuator connection through the spring, may not be greater in any state of the actuator connection, in any rotational position of the actuator connection, than 30%, in particular not greater than 15%, and/or not greater than 5%, of the nominal torque at the actuator connection through the motor by means of the gear mechanism. This is because it has been shown that even a very “weak” spring, which applies torque of not greater than the 5% of the nominal torque at the actuator connection applied by the motor by means of the gear mechanism to the actuator connection, may be suitable for effectively suppressing a backlash between the gear wheels. Thus the said risks, in particular with the usual negative loads when used in a system for heating, ventilation, or cooling in a building, are negligible.

In some embodiments, the nominal torque at the actuator connection applied by the motor by means of the gear mechanism means the maximum torque that the motor can deliver over the long term at the actuator connection at the rotational speeds usual during operation. The nominal torque thus differs from the maximum holding torque that the motor can deliver in the stationary state. This is comparatively small with an electric motor however.

In some embodiments, in each state of the actuator connection, in each rotational position of the actuating drive, the spring is suitable to act on it in the same direction. Thus, there is no area of the actuator connection in which the spring barely exerts force or even exerts force in different directions. The spring is pre-tensioned for this purpose. In some embodiments, it is suitable, in each state of the actuator connection, in each rotational direction of the actuating drive, to act on it with a force or with a torque that is greater than 20% of the maximum force of the maximum torque, with which it acts on it in the optimum state of the actuator connection, in the optimum rotational position of the actuator connection.

Such a weak spring, which however can stretch over the entire path of the actuator connection and has been pre-tensioned over a distance of a similar magnitude, may include a bending spring. This can be accommodated in a compact manner within an actuating drive housing. With an actuator connection that is suitable for rotation when driven by the motor, the spring may be arranged at a distance from the axis of rotation and essentially obliquely thereto. A bending spring can be laid in a roughly circular shape around the axis of rotation.

Such a bending spring may include a torsion spring. Such a torsion spring can be a coil spring or a cylindrical spring or a spiral spring. It can also be a combination of said springs. The torsion spring may be arranged coaxially to the axis of rotation of the actuator connection. In some embodiments, a first end of the torsion spring is fastened to the housing of the actuating drive in the sense of a torque support, while a second end of the torsion spring, to apply a torque at the actuator connection, engages at a distance from the axis of rotation of the actuator connection.

The spring might also act indirectly or remotely on the actuator connection. It may also act on the actuator connection by its end being fastened to a body that is suited for its part to acting directly on the actuator connection. The arm can act in the sense of an eccentric, for example the spring is fastened on one side to the housing, and on the other side to an arm, which again is fastened by a screw to the actuator connection. In some embodiments, the body is a gear wheel, which together with the last gear wheel of the gear mechanism, in parallel, engages with a complementary toothed segment of the rotatable actuator connection.

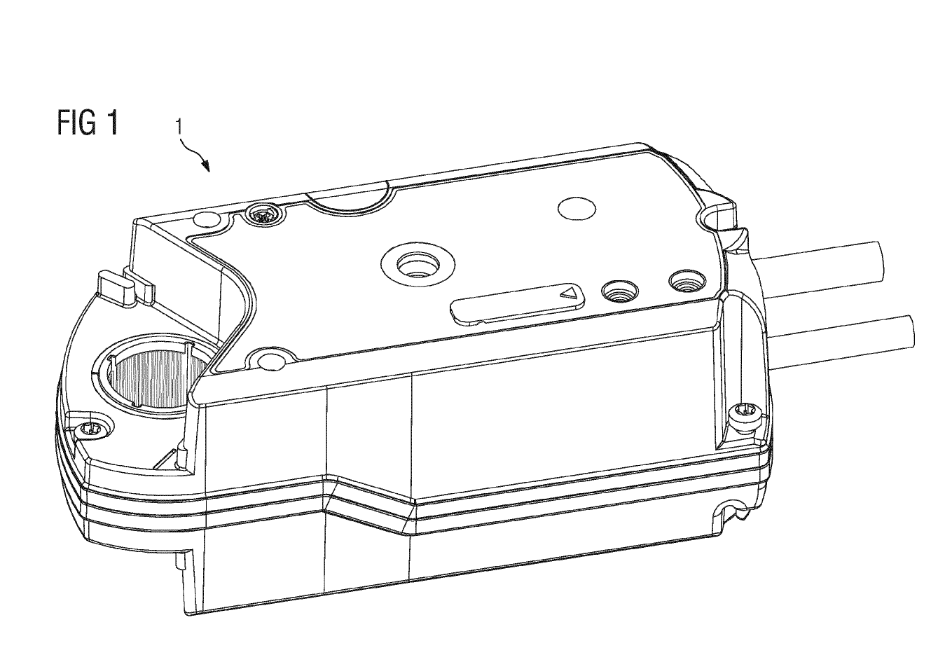

FIG. 1 shows an actuating drive 1, which can actuate an air flap in a system for heating, ventilation, and/or cooling in a building. In the event of a fire, it is designed to put the air flap into a specific position, to delay the spread of smoke, or in order to explicitly enable smoke to escape. So that this emergency position is securely assumed even in the event of an outage of the external power supply, the actuating drive 1 contains electrochemical capacitors for the purposes of storing electrical charge. In some embodiments, typically with actuating drives that have an emergency position in any event, a return spring is used for this purpose.

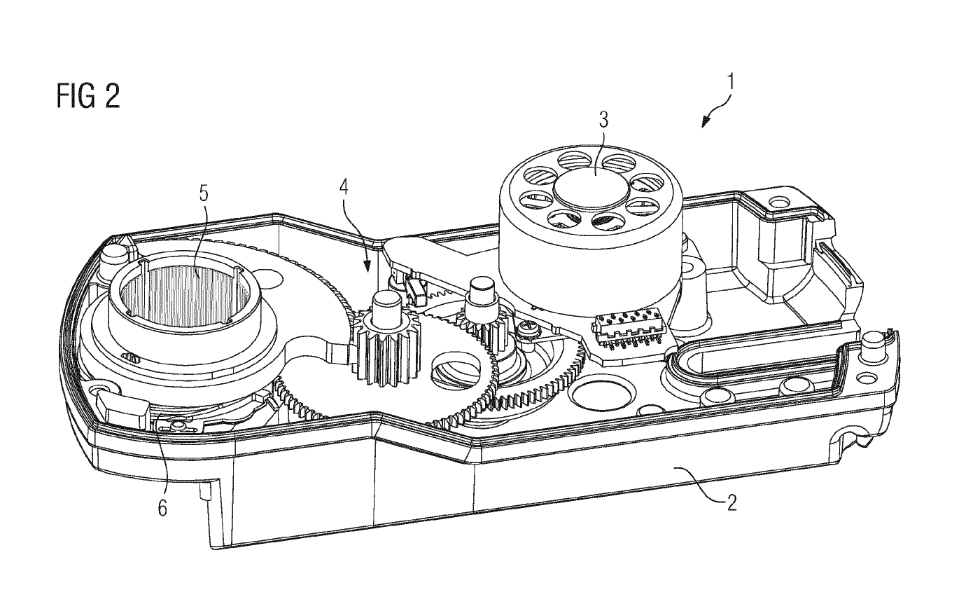

The bidirectional electric motor 3 in FIG. 2 is capable of moving an air flap of a specific size into the defined position within 2 seconds in case of emergency. It is therefore dimensioned comparatively large with a nominal torque of 77 mNm. After the transmission ratio is changed by the gear mechanism 4, the electric motor 3 generates a nominal torque of 6 Nm at the actuator connection 5. At its maximum opening angle of 90°, the bending spring 6 exerts a torque of 90 mNm. The spring pulls the actuator connection 5 in the direction of smaller opening angles. It is pre-tensioned by 80° and thus, with a minimum opening angle of 0°, still generates a torque of around 40 mNm in the same direction of drive.

In some embodiments, the electric motor 3 is suitable for producing a nominal power of 5 W. Compared to this the power of the bending spring 6 is up to 0.1 W at the maximum opening angle of 90°.

In some embodiments, the actuator connection 5 has a toothed segment, which engages in the last gear wheel of the gear mechanism 4. The actuator connection 5 is formed by a metal cylinder, to accommodate an external air flap shaft via an adapter element. The adapter element is held in a form fit, by means of grooves and clamping elements. The actuator connection 5 is accommodated rotatably in the housing 2 by means of a friction bearing made of plastic.

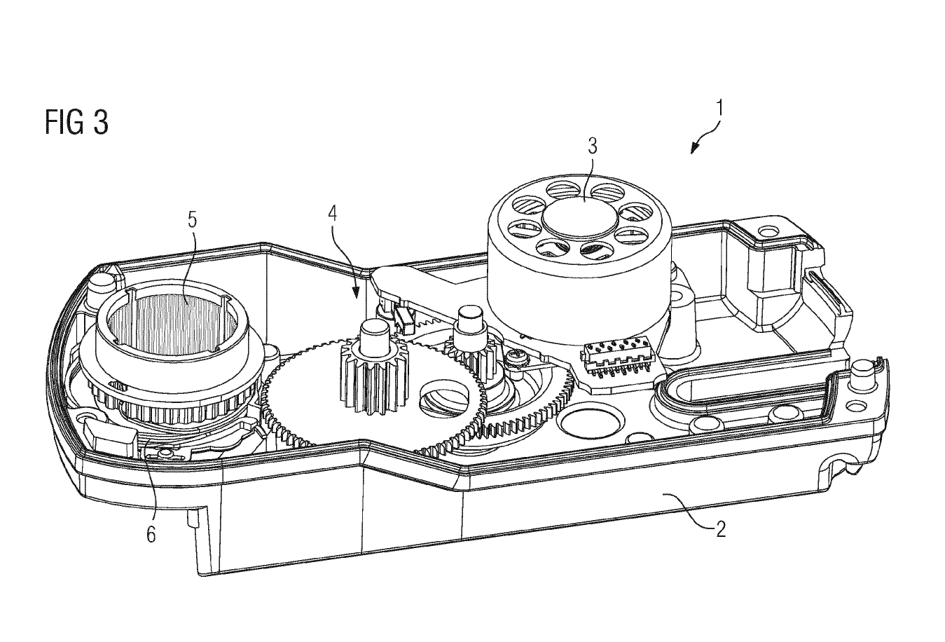

FIG. 3 shows that the gear mechanism 4 comprises two rotatably mounted shafts with two gear wheels mounted thereon in each case. The shafts consist of steel, the gear wheels partly of steel and partly of a plastic. The gear mechanism 4 translates the rotation of a gear wheel not shown in the figure on the driveshaft of the electric motor 3 into an around four hundred times slower rotation of the toothed segment of the actuator connection 5.

In some embodiments, the actuating drives have a motor with a lower power potential, which is why the gear mechanism contains a larger gear wheel chain, usually with up to six such gear wheel shafts, instead of just two. A return spring typically engages roughly in the middle of this chain.

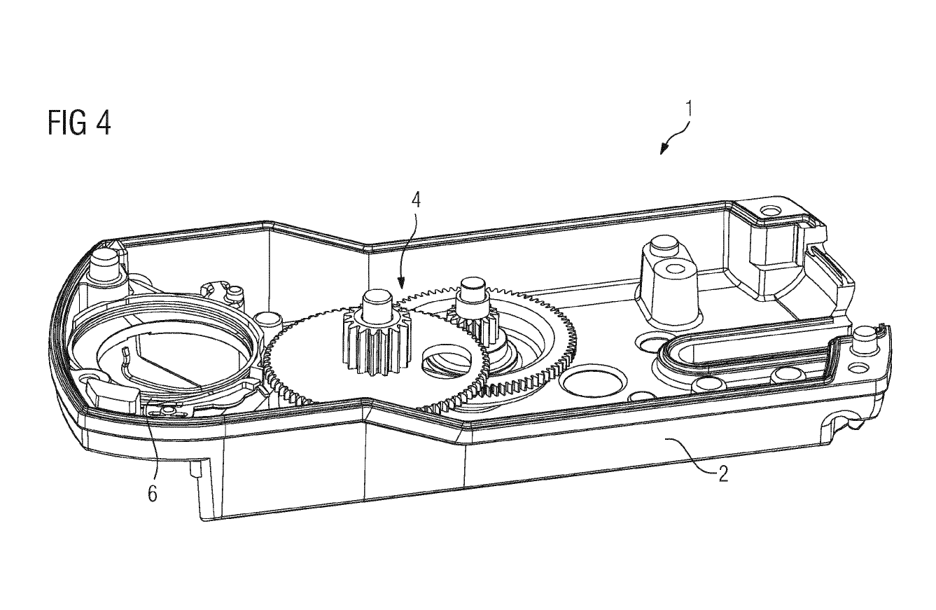

It can be seen in FIG. 4 that the bending spring 6 lies in a spiral around the actuator connection not shown in the figure, and that it is curved at its two ends. The one end engages in a cutout of a body fastened to the housing. The other end is pushed into a hole in a ring-shaped part of the actuator connection not shown in the figure. Thus, a rotation of the actuator connection not shown in the figure triggers a tensioning or relaxation of the bending spring 6. In this sense the bending spring 6 acts in the drive direction on the actuator connection not shown.

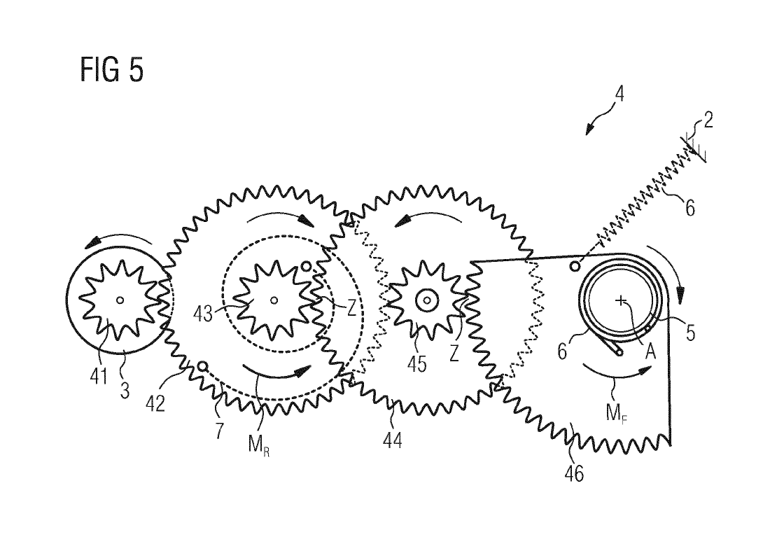

FIG. 5 shows a schematic diagram of a gear mechanism 4 of the inventive actuating drive 1 in its idle position with a return spring 7 for reversing operation and with a spring 6 acting directly on the actuator connection 5.

In some embodiments, the gear mechanism 4 has a motor-side gear wheel 41 for reduction, a take-off-side gear wheel 46 as part of the actuator connection 5 as well as four gear wheels 42-45 connected between the two, of which two gear wheels 42, 43; 44, 45 in each case are arranged coaxially in relation to one another and are connected to one another in a torsion-proof manner. The take-off-side gear wheel 46 is embodied as a 90° toothed segment, since only one rotational movement of 90° is needed at the actuator connection 5.

The reference number 7 refers to a return spring embodied as a wrap spring or as a spiral spring. This return spring 7 applies an increasing resetting torque M_{R} against the drive direction to the actuating drive 1 with increasing movement of the actuating drive 1 from the idle position into an actuation position, i.e. in the drive direction shown by the arrows. In this case, during the actuation process, the tooth flanks of the first and second gear wheel 41, 42 lie against one another without any play, i.e. without backlash Z. At the same time the tooth flanks of the other gear wheels 43-46, until the actuation position is reached, lie against one another without any play.

With the start of reverse operation, however, the tooth flank of gear wheel 43 now strikes the tooth flank of gear wheel 44 by the backlash Z and subsequently the tooth flank of gear wheel 45 strikes the tooth flank of gear wheel 46 or of the toothed segment by backlash Z. This striking against one another causes annoying “knocking” noises as well as increased wear on the teeth that are engaging with one another.

However, it is also possible in the idle position for a change in load at a valve or at a flap, which is connected to the actuator connection 5, to feed back via the actuator connection 5 to the actuating drive 1. This can for example be changes in pressure in a pressure line connected to the valve. It can however also be pressure fluctuations, such as e.g. a gust of wind, which act on a flap. These feedbacks via the actuator connection 5 cause the “free” gear wheels 44, 45, 46, which do not lie against each other without any play through a pre-tensioning of the return spring 7, to knock against one another. These collisions may once again produce annoying “knocking” noises as well as increased wear on the teeth that are engaging with one another.

In some embodiments, the spring 6 acting on the actuator connection 5, all tooth flanks of the gear wheels 41-46 now lie against one another without any play and without backlash. This is achieved by the torque M_{F} of the spring 6 acting on the actuator connection 5 against the direction of drive. Here a slight pre-tensioning of the spring 6 against the drive direction is already sufficient in the idle position of the actuating drive. With increasing movement of the actuating drive from the idle position into the actuation position the torque M_{F} of the spring gradually increases and acts at the same time against the drive direction. Thus, in each rotational position of the actuator connection 5, a torque M_{F} of the spring 6 acts on the actuator connection 5 against the drive direction.

In some embodiments, the spring 6 comprises a torsion spring. It is arranged coaxially to the axis of rotation A of the actuator connection 5 and is pre-tensioned against the drive direction. In this case the one end of the torsion spring 6 is connected firmly and at a distance from the axis of rotation A to the actuator connection 5 or to the gear wheel 46 or toothed segment of the actuator connection 5. The other end of the torsion spring 6 engages in this case into a housing-side support not shown in any greater detail.

In some embodiments, the coil spring shown by a dashed outline can also be used as compression spring 6, which engages with its one end in the housing 2 of the actuating drive with its other end in a support on the actuator connection 5 not referred to in any further detail.

What is claimed is:

1. An actuating drive comprising:
a motor;
a gear mechanism;
an actuator connection, wherein the motor drives the actuator connection through the gear mechanism; and
a spring suitable to act on the actuator connection independently of the gear mechanism.

2. The actuating drive as claimed in claim 1, further comprising:
a housing;
wherein the spring includes a first and a second end, the first end of the spring connected to the housing and the second end of the spring fastened to the actuator connection to act directly with a torque on the actuator connection.

3. The actuating drive as claimed in claim 1, further comprising:
a housing;
wherein the spring has a first and a second end, the first end of the spring connected to the housing and the second end of the spring fastened to a body applying a torque directly to the actuator connection.

4. The actuating drive as claimed in claim 3, wherein the body comprises a gear wheel, a toothed segment, an arm, or a connecting rod.

5. The actuating drive as claimed in claim 1, wherein the spring is pre-tensioned to act on the actuator connection with a torque in each rotational position of the actuator connection.

6. The actuating drive as claimed in claim 1, wherein the spring, in each rotational position of the actuator connection, acts on the actuator connection in a first direction or in a second direction opposite to said direction.

7. The actuating drive as claimed in claim 1, wherein the spring, in each rotational position of the actuator connection, acts on the actuator connection with a torque greater than 20% of a maximum torque with which the spring acts on the actuator connection in an optimum rotational position of the actuator connection.

8. The actuating drive as claimed in claim 1, wherein, without actuation of the motor, the spring does not drive a non-connected actuator connection in any rotational position of the actuator connection.

9. The actuating drive as claimed in claim 1, wherein the spring comprises a bending spring, a torsion spring, a tension spring, or a compression spring having an axis of rotation.

10. The actuating drive as claimed in claim 9, wherein the spring is arranged coaxially to the axis of rotation of the actuator connection.

11. The actuating drive as claimed in claim 1, wherein a torque applied by the spring to the actuator connection, no matter the rotational position of the actuator connection, is less than 15%, of the nominal torque at the actuator connection applied by the motor by means of the gear mechanism.

12. The actuating drive as claimed in claim 1, wherein the motor drives, by means of the gear mechanism, the actuator connection in a first direction and in a second, opposite direction thereto.

13. The actuating drive as claimed claim 1, wherein the gear mechanism includes:
a motor-side gear wheel;
a take-off-side gear wheel as part of the actuator connection; and
a gear wheel connected between the motor-side gear wheel and the take-off-side gear wheel;
wherein the gear wheel is connected to a return spring applying a reversing torque to the actuating drive for a reverse operation, in the event of the drive being deflected from an idle position; and
wherein the spring is pre-tensioned, in order, in each rotational position of the actuator connection, to act with a torque on the actuator connection against the drive direction of the actuator connection from the idle position into an actuation direction.

14. The actuating drive as claimed in claim 1, wherein the motor comprises a brushless direct current electric motor.

15. The actuating drive as claimed in claim 1, wherein the actuating drive actuates a component in a system for heating, ventilation or cooling in a building.
